(19) United States
(12) Patent Application Publication
(10) Pub. No.: US 2024/0255668 A1
(43) Pub. Date: Aug. 1, 2024

(54) GEOSTEERING USING IMPROVED DATA CONDITIONING

(71) Applicant: SAUDI ARABIAN OIL COMPANY, Dhahran (SA)

(72) Inventors: Klemens Katterbauer, Dhahran (SA); Abdallah A. Alshehri, Dhahran (SA); Alberto Marsala, Venezia (IT); Ali Abdallah Alyousef, Dhahran (SA)

(73) Assignee: SAUDI ARABIAN OIL COMPANY, Dhahran (SA)

(21) Appl. No.: 18/162,592

(22) Filed: Jan. 31, 2023

(51) Int. Cl. G01V 1/48; E21B 7/04; G01V 1/46

(52) U.S. Cl. CPC G01V 1/48; E21B 7/04; G01V 1/46

(57) ABSTRACT

Systems and methods for geosteering using improved data conditioning are disclosed. The methods include estimating physical parameters from a training dataset including remote sensing data; preprocessing the estimated physical parameters; training a first neural network; training a second neural network; training a third neural network; converting estimated physical parameters into the rock characteristics with the first neural network; and converting rock characteristics into reconciled physical parameters with the second neural network. The methods further include obtaining new remote sensing data; estimating new estimated physical parameters from the new remote sensing data; converting new estimated physical parameters into new reconciled physical parameters with the third neural network; and performing geosteering of a well based on a subsurface geology interpreted from the new reconciled physical parameters.

### CROSS-REFERENCE TO RELATED APPLICATIONS

This application is related to co-pending application serial number ______, titled “METHODS AND SYSTEMS FOR PREDICTING CONDITIONS AHEAD OF A DRILL BIT” (attorney docket number 18733-1066001) filed on the same date as the present application and co-pending application serial number ______, titled “Geosteering using reconciled subsurface physical parameters” (attorney docket number 18733-1075001) filed on the same date as the present application. These co-pending patent applications are hereby incorporated by reference herein in their entirety.

### BACKGROUND

When planning the path of a well, it is advantageous to know the lithology, saturation, and associated physical properties of subsurface rock formations ahead of the drill bit. This allows preemptive geosteering wellbore trajectory changes to be made before the wellbore its target zone, e.g. the reservoir. The required information may be derived from a variety of sources, including seismic and electromagnetic (EM) surveys obtained from the surface, seismic and EM data obtained by sensors near the drill bit during drilling, as well as from logging while drilling (LWD). The quality of the estimates of the physical parameters is dependent on the quality of the data used to estimate them. Accordingly, there exists a need for reconciling the LWD, EM, and seismic data obtained from the drill bit with each other and with the larger-scale pre-drilling data before predicting subsurface lithology and associated properties.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments are disclosed related to methods for geosteering using improved data conditioning. The methods include estimating physical parameters from a training dataset including remote sensing data; preprocessing the estimated physical parameters; training a first neural network; training a second neural network; training a third neural network; converting estimated physical parameters into the rock characteristics with the first neural network; and converting rock characteristics into reconciled physical parameters with the second neural network. The methods further include obtaining new remote sensing data; estimating new estimated physical parameters from the new remote sensing data; converting new estimated physical parameters into new reconciled physical parameters with the third neural network; and performing geosteering of a well based on a subsurface geology interpreted from the new reconciled physical parameters.

In general, in one aspect, embodiments are disclosed related to a non-transitory computer-readable memory comprising computer-executable instructions stored thereon that, when executed on a processor, cause the processor to perform the steps of geosteering using improved data conditioning. The steps include estimating physical parameters from a training dataset including remote sensing data; preprocessing the estimated physical parameters; training a first neural network; training a second neural network; training a third neural network; converting estimated physical parameters into the rock characteristics with the first neural network; and converting rock characteristics into reconciled physical parameters with the second neural network. The steps further include obtaining new remote sensing data; estimating new estimated physical parameters from the new remote sensing data; converting new estimated physical parameters into new reconciled physical parameters with the third neural network; and performing geosteering of a well based on a subsurface geology interpreted from the new reconciled physical parameters.

In general, in one aspect, embodiments are disclosed related to systems configured for geosteering using improved data conditioning. The systems include a geosteering system configured to guide a drill bit in a well and a computer system configured to estimate physical parameters from a training dataset including remote sensing data; preprocess the estimated physical parameters; train a first neural network; train a second neural network; train a third neural network; convert estimated physical parameters into the rock characteristics with the first neural network; and convert rock characteristics into reconciled physical parameters with the second neural network. The computer system is further configured to obtain new remote sensing data; estimate new estimated physical parameters from the new remote sensing data; convert new estimated physical parameters into new reconciled physical parameters with the third neural network; and perform geosteering of a well based on a subsurface geology interpreted from the new reconciled physical parameters.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a drilling system in accordance with one or more embodiments.

FIG. 2A shows a neural network in accordance with one or more embodiments.

FIG. 2B shows relationship between remote sensing data, physical parameters, lithology and saturation, and a first convolutional neural network according to one or more embodiments.

FIG. 2C shows relationship between remote sensing data, physical parameters, lithology and saturation, and a second convolutional neural network according to one or more embodiments.

FIG. 2D shows the conversion of estimated physical parameters into predicted rock characteristics with a first neural network, and the conversion of predicted rock characteristics into predicted physical parameters with a second neural networks according to one or more embodiments.

FIG. 2E shows relationship between estimated physical parameters, reconciled physical parameters, and a third neural network according to one or more embodiments.

FIG. 2F shows the conversion of estimated physical parameters into reconciled physical parameters with a third neural network according to one or more embodiments.

FIG. 3 shows a flowchart according to one or more embodiments.

FIG. 4 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

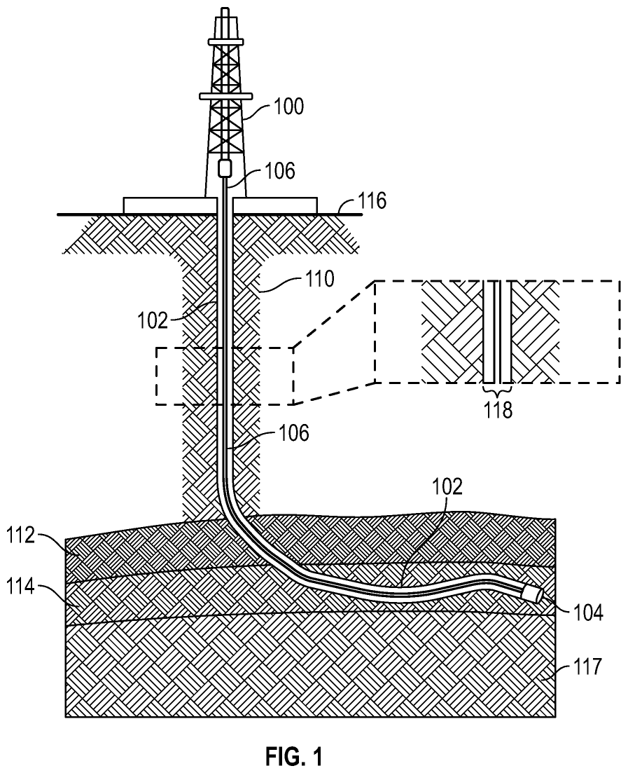

In the following description of FIGS. 1-4, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a wellbore” includes reference to one or more of such wellbores.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims may not be introduced, it would be apparent to one of ordinary skill that the subject matter of the dependent claims directed to one or more embodiments may be combined with other dependent claims.

In one aspect, embodiments disclosed herein relate to reconciling physical parameters estimated from LWD, EM while drilling data, and seismic while drilling data obtained at the drill bit with each other and with physical parameters estimated from deep remote sensing data pre-drilling surveys. The deep remote sensing data may be, without limitation, surface EM data, surface seismic data, and gravity data.

The embodiments of the present disclosure may provide at least the following advantage: a deep learning method for automatized reconciliation of physical parameters (e.g., acoustic impedance and resistivity) estimated from various geophysical data sources, where expert information may be taken into account via adjusting the weights of a neural network. The reconciliation implies that estimated physical parameters are consistent with each other, thus removing interpretation conflicts. The reconciled physical parameters may be used to predict other related physical variables (e.g., saturation) ahead of the drill bit for geosteering purposes.

EM methods measure electric or magnetic fields at the surface of the Earth or in boreholes in order to determine electrical properties (i.e., electrical resistivity, electrical permeability or electrical permittivity) in the subsurface. Electromagnetic or electrical logging is major technique used in oil exploration to measure the amount of hydrocarbons in the pores of underground reservoirs. Inductive EM methods include a variety of techniques that deploy wire coils at or near the surface and transmit low frequency (a few Hz to several kHz) waves into the subsurface. Other EM modalities include direct current (electrical or resistivity methods), induced polarization (IP), microwave frequencies (i.e., ground-penetrating radar), and methods that use natural electromagnetic fields (i.e., magnetotelluric methods). Ground-penetrating radar (GPR) uses antennae as sources to send time varying signals into the surface which reflect off subsurface structures. Whereas induction, induced polarization, magnetotelluric, and direct current methods provide lower resolution information, the higher frequency GPR methods may delineate smaller subsurface features. However, GPR methods are limited to penetrating only a few hundred feet into the subsurface.

Seismic methods send seismic waves (analogous to the electromagnetic waves used in GPR) into the subsurface where they reflect off of geological structures and are recorded by sensors in boreholes or on the surface. For exploration purposes, seismic methods allow practical exploration tens of thousands of feet into the subsurface.

FIG. 1 illustrates systems in accordance with one or more embodiments. Specifically, FIG. 1 shows a well (102) that may be drilled by a drill bit (104) attached by a drillstring (106) to a drill rig (100) located on the surface of the earth (116). The borehole (118) corresponds to the uncased portion of the well (102). The borehole (118) of the well may traverse a plurality of overburden layers (110) and one or more cap-rock layers (112) to a hydrocarbon reservoir (114). As the well (102) is being drilled, tools located near the drill bit (104) may perform physical measurements resulting in different geophysical remote sensing data sets (e.g., LWD, seismic while drilling, EM while drilling). LWD data may include neutron porosity data, borehole caliber data, nuclear magnetic resonance data, gamma ray data, weight on bit data, rate of penetration data, inclination data, measured depth data, true vertical depth data, bearing data, temperature data, pressure data, sonic, deep azimuthal resistivity, and density logs. Surface seismic and surface EM data may also be obtained from larger-scale, deep remote sensing surveys of the subsurface conducted prior to drilling.

The geosteering system may include functionality for monitoring various sensor signatures (e.g., an acoustic signature from acoustic sensors) that gradually or suddenly change as a well path traverses overburden layers (110), cap-rock layers (112), or enters a hydrocarbon reservoir (114) due to changes in the lithology between these regions. For example, a sensor signature of the hydrocarbon reservoir (114) may be different from the sensor signature of the cap-rock layer (112). When the drill bit (104) drills out of the hydrocarbon reservoir (114) and into the cap-rock layer (112) a detected amplitude spectrum of a particular sensor type may change suddenly between the two distinct sensor signatures. In contrast, when drilling from the hydrocarbon reservoir (114) downward into the bed rock (117), the detected amplitude spectrum may gradually change.

During the lateral drilling of the borehole (118), preliminary upper and lower boundaries of a formation layer's thickness may be derived from a deep remote sensing survey and/or an offset well obtained before drilling the borehole (118). If a vertical section of the well is drilled, the actual upper and lower boundaries of a formation layer may be determined beneath one spatial location on the surface of the Earth. Based on well data recorded during drilling, an operator may steer the drill bit (104) through a lateral section of the borehole (118) making trajectory adjustments in real time based upon reading of sensors located at, or immediately behind, the drill bit. In particular, a logging tool may monitor a detected sensor signature proximate the drill bit (104), where the detected sensor signature may continuously be compared against prior sensor signatures, e.g., of signatures detected in the cap-rock layer (112), hydrocarbon reservoir (114), and bed rock (117). As such, if the detected sensor signature of drilled rock is the same or similar to the sensor signature of the hydrocarbon reservoir (114), the drill bit (104) may still be traversing the hydrocarbon reservoir (114). In this scenario, the drill bit (104) may be operated to continue drilling along its current path and at a predetermined distance from a boundary of the hydrocarbon reservoir. If the detected sensor signature is the same as or similar to sensor signatures of the cap-rock layer (112) or the bed rock (117), recorded previously, then the geosteering system may determine that the drill bit (104) is drilling out of the hydrocarbon reservoir (114) and into the upper or lower boundary of the hydrocarbon reservoir (114), respectively. At this point, the vertical position of the drill bit (104) below the surface may be determined and the upper and lower boundaries of the hydrocarbon reservoir (114) may be updated.

The various geophysical data sets obtained are related to different physical parameters of the rock formations through which the drill bit (104) passes. For instance, seismic data may provide information on acoustic impedance, EM data may provide information on the resistivity of the rocks, and gravity data may provide information on rock density. Using at least some of the physical parameters estimated from the geophysical data, embodiments of the disclosure may enable determination of formation properties including lithology and saturation patterns ahead of the drill bit (104) to enable geosteering.

A signal-to-noise ratio of the measured physical parameters may be used to categorize the measurements based on their quality (e.g., from 1 to 5, where 1 is the poorest quality and 5 is the best quality, or vice versa). Z-score analysis may also be used to evaluate the quality of the estimated physical parameters. Additionally, the physical parameters may be categorized based on the resolution they can attain. The noise in the estimated physical parameters may come from noise in the geophysical data which may have arisen from defective equipment, operator error, and other sources. Outliers in the noisy estimated physical parameters may be discarded as part of a preprocessing step. Otherwise, the estimated physical parameters must be processed for correction and reconciled with each other in order to obtain a consistent interpretation of all data.

In accordance with one or more embodiments, the estimated physical parameters are related to rock characteristics, such as rock type (lithology) and fluid saturation. These physical parameters may be numerical values and the related variables may be categorical (e.g., lithology) or numerical (e.g., saturation). However, the type of estimated physical parameters and the related variable in the present embodiment should not be interpreted as limiting the scope of the invention. The same method may apply to any numerical, ordinal, or categorical physical parameter estimated from data and any numerical, ordinal, or categorical variable related to that parameter. Relationships may exist between the physical parameters, e.g., porosity and permeability.

Linking the estimated physical parameters (e.g., acoustic impedance and resistivity) to another physical variable (e.g., saturation) requires constructing a relationship that uses the estimated physical parameters to determine the value of the other variable. Machine learning (ML) methods are general purpose functions that can accomplish this task. It is assumed that there exists information from nearby wells or other fields that can be used as training data for the ML methods to link the physical parameters with their related variables. The training data may also be derived from realistic synthetic simulations.

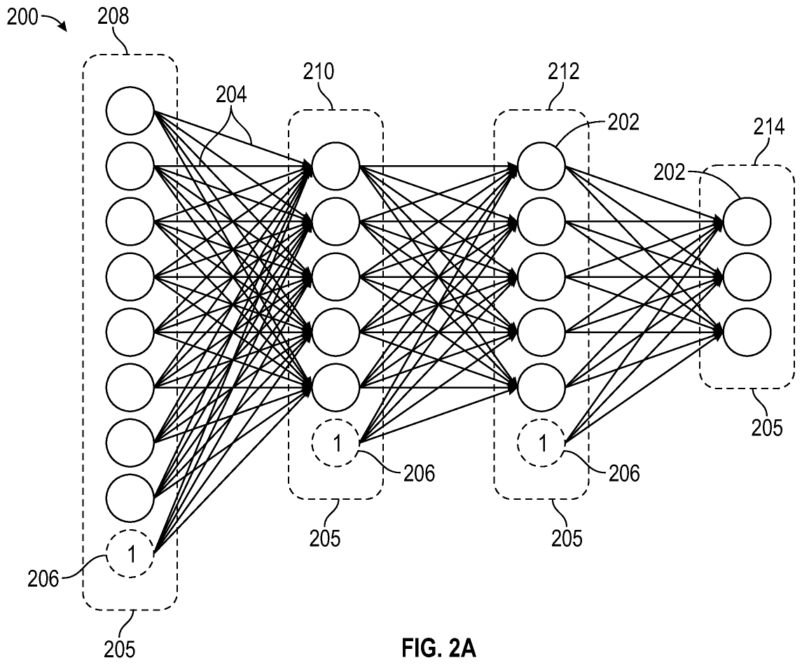

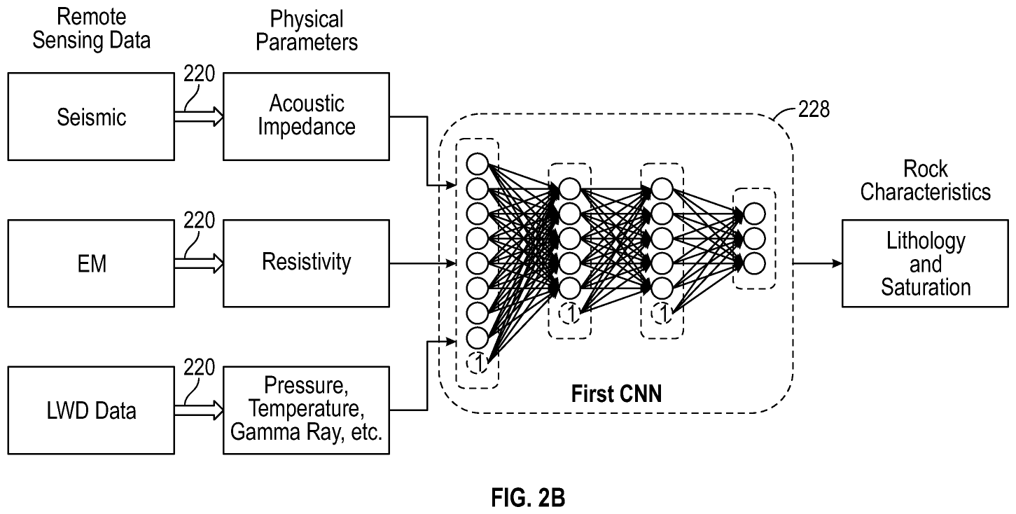

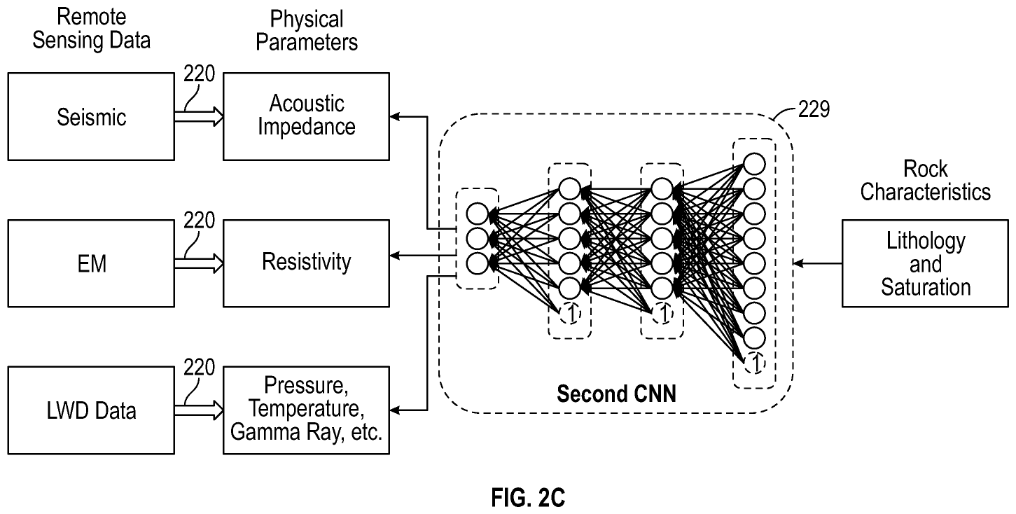

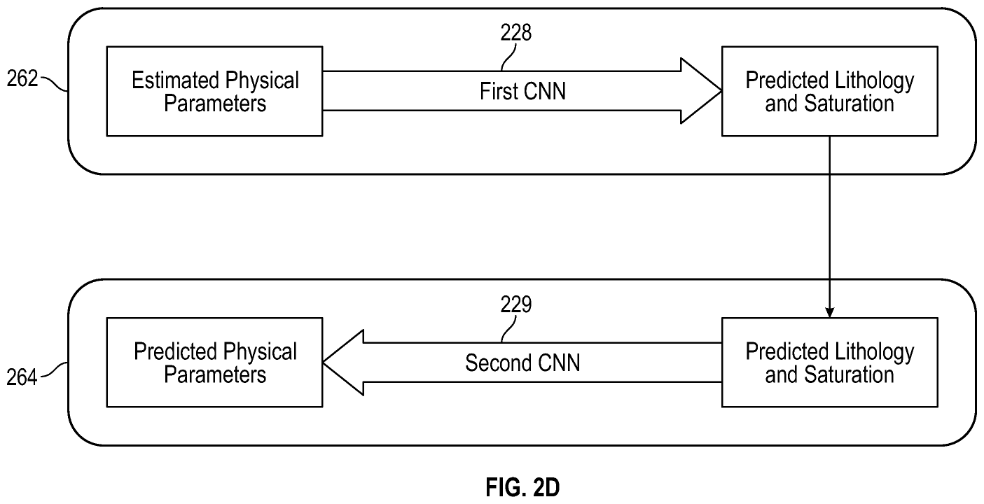

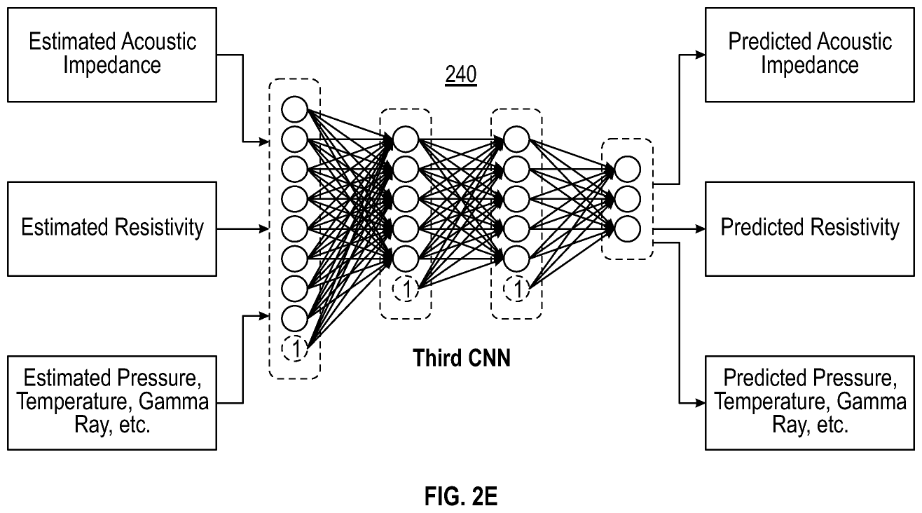

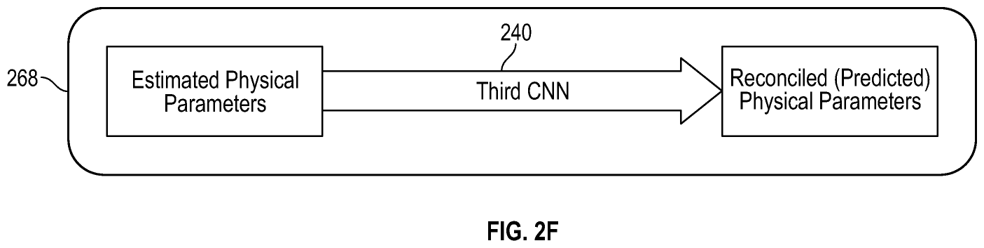

FIG. 2A shows a neural network, a common ML architecture for prediction/inference. At a high level, a neural network (200) may be graphically depicted as comprising nodes (202), shown here as circles, and edges (204), shown here as directed lines connecting the circles. The nodes (202) may be grouped to form layers, such as the four layers (208, 210, 212, 214) of nodes (202) shown in FIG. 2A. The nodes (202) are grouped into columns for visualization of their organization. However, the grouping need not be as shown in FIG. 2A. The edges (204) connect the nodes (202). Edges (204) may connect, or not connect, to any node(s) (202) regardless of which layer (205) the node(s) (202) is in. That is, the nodes (202) may be fully or sparsely connected. A neural network (200) will have at least two layers, with the first layer (208) considered as the “input layer” and the last layer (214) as the “output layer.” Any intermediate layer, such as layers (210) and (212) is usually described as a “hidden layer”. A neural network (200) may have zero or more hidden layers, e.g., hidden layers (210) and (212). However, a neural network (200) with at least one hidden layer (210, 212) may be described as a “deep” neural network forming the basis of a “deep learning method.” In general, a neural network (200) may have more than one node (202) in the output layer (214). In this case the neural network (200) may be referred to as a “multi-target” or “multi-output” network.

Nodes (202) and edges (204) carry additional associations. Namely, every edge is associated with a numerical value. The numerical value of an edge, or even the edge (204) itself, is often referred to as a “weight” or a “parameter”. While training a neural network (200), numerical values are assigned to each edge (204). Additionally, every node (202) is associated with a numerical variable and an activation function. Activation functions are not limited to any functional class, but traditionally follow the form:

$$A = f ( {\sum }_{i ∈ ( i n c o min g )} [ {( node value )}_{i} {( edge value )}_{i} ] ) , \qquad ( 1 )$$

where i is an index that spans the set of “incoming” nodes (202) and edges (204) and ƒ is a user-defined function. Incoming nodes (202) are those that, when viewed as a graph (as in FIG. 2A), have directed arrows that point to the node (202) where the numerical value is computed. Functional forms of ƒ may include the linear function ƒ(x)=x, sigmoid function

$$f ( x ) = \frac{1}{1 + {e}^{- x}} ,$$

and rectified linear unit function ƒ(x)=max(0,x), however, many additional functions are commonly employed in the art. Each node (202) in a neural network (200) may have a different associated activation function. Often, as a shorthand, activation functions are described by the function ƒ by which it is composed. That is, an activation function composed of a linear function ƒ may simply be referred to as a linear activation function without undue ambiguity.

When the neural network (200) receives an input, the input is propagated through the network according to the activation functions and incoming node (202) values and edge (204) values to compute a value for each node (202). That is, the numerical value for each node (202) may change for each received input. Occasionally, nodes (202) are assigned fixed numerical values, such as the value of 1, that are not affected by the input or altered according to edge (204) values and activation functions. Fixed nodes (202) are often referred to as “biases” or “bias nodes” (206), and are depicted in FIG. 2A with a dashed circle.

In some implementations, the neural network (200) may contain specialized layers (205), such as a normalization layer, or additional connection procedures, like concatenation. One skilled in the art will appreciate that these alterations do not exceed the scope of this disclosure.

As noted, the training procedure for the neural network (200) comprises assigning values to the edges (204). To begin training, the edges (204) are assigned initial values. These values may be assigned randomly, assigned according to a prescribed distribution, assigned manually, or by some other assignment mechanism. Once edge (204) values have been initialized, the neural network (200) may act as a function, such that it may receive inputs and produce an output. As such, at least one input is propagated through the neural network (200) to produce an output. Recall that a given data set will be composed of inputs and associated target(s), where the target(s) represent the “ground truth”, or the otherwise desired output. The neural network (200) output is compared to the associated input data target(s). The comparison of the neural network (200) output to the target(s) is typically performed by a so-called “loss function”; although other names for this comparison function such as “error function” and “cost function” are commonly employed. Many types of loss functions are available, such as the mean-squared-error function. However, the general characteristic of a loss function is that it provides a numerical evaluation of the similarity between the neural network (200) output and the associated target(s). The loss function may also be constructed to impose additional constraints on the values assumed by the edges (204), for example, by adding a penalty term, which may be physics-based, or a regularization term. Generally, the goal of a training procedure is to alter the edge (204) values to promote similarity between the neural network (200) output and associated target(s) over the data set. Thus, the loss function is used to guide changes made to the edge (204) values, typically through a process called “backpropagation.”

The loss function will usually not be reduced to zero during training. And, once trained, it is not necessary or required that the neural network (200) exactly reproduce the output elements in the training data set when operating upon the corresponding input elements. Indeed, a neural network (200) that exactly reproduces the output for its corresponding input may be perceived to be “fitting the noise.” In other words, it is often the case that there is noise in the training data, and a neural network (200) that is able to reproduce every detail in the output is reproducing noise rather than true signal. The price to pay for using such a “perfect” neural network (200) is that it will be limited to fitting only the training data and not able to generalize to produce a realistic output for a new and different input that has never been seen by it before. An analog of this problem occurs when fitting a polynomial to data points. The higher the degree of the polynomial, the closer the resulting curve will be to fitting all the points (a high enough polynomial is guaranteed to fit all the points). However, higher degree polynomials will tend to diverge quickly away from the fit data point values—hence, a high degree polynomial will not exhibit generalizability.

Assuming a trained neural network (200) in this invention only approximately reproduces outputs for corresponding inputs, one may perform the following operation: a first neural network will be trained with estimated physical parameters as the input and rock characteristics as the output. Next, a second neural network will be trained on the same training data set in the opposite direction. The second neural network will take the rock characteristics as input and estimated physical parameters as outputs.

Once trained, the first neural network will be applied to a new input data set of estimated physical parameters, thus producing predicted rock characteristics as output. The second neural network will then be applied using the outputs of the first neural network as its inputs. This second neural network will produce predicted physical parameters. These predicted physical parameters should have benefited from being passed through the two neural networks; they should be less noisy and they should have picked up realistic spatial patterns from the rock characteristics.

At this point a third neural network is trained. It will use the estimated physical properties as its input and the predicted physical properties as its output. The idea here be able to convert estimated physical parameters to reconciled (i.e., predicted) physical parameters in one step, without needing to predict rock characteristics as an intermediate step. This third neural network may be viewed as a “denoiser”; i.e., it produces reconciled physical parameters that have been denoised and exhibit realistic spatial patterns seen in the rock characteristic training data. The reconciled physical parameters should also be more consistent with each other and thus serve better for interpretation or for any further processing workflows that make use of them.

In accordance with one or more embodiments, the neural networks (200) described above may be convolutional neural networks (CNN). The first CNN (228) (the first neural network mentioned above) may take physical parameters, such as impedance, resistivity, log values, defined on a grid over a three dimensional volume as its input, and produces a grid of related rock characteristics defined over the same grid as its output. The second CNN (229) does the same as the first CNN (228), only in the opposite direction, i.e., the second CNN (229) produces physical parameters from related rock characteristics. The third CNN (240) takes estimated physical parameters defined over a three dimensional grid and converts them to reconciled physical parameters, defined at the same points on the three dimensional grid.

A training data set for the first CNN (228) and second CNN (229) may come from offset wells or wells from another field where data was previously collected, and the values of both physical parameters and the lithology or saturation are known at the same locations. Some pairs of previously recorded data may be reserved for testing and evaluation purposes rather than included in the training dataset. The third CNN (240) may then be trained on the estimated physical parameters from the training set and the reconciled (predicted) physical parameters output by the second CNN (229). Once trained, the third CNN (240) may be applied to estimates of physical parameters on a three dimensional grid at a new location. The third CNN (240) may output a denoised version of the same field of physical parameters.

CNN's, being “convolutional,” assume a certain translational invariance in the parameter being output. In other words, the third CNN (240) (the “denoiser”) assumes that the noise present in a particular estimated physical parameter only depends on the values of estimated parameters at neighboring grid cells, along with the value of other estimated physical parameters at the same location and in the same neighborhood; the noise present in a physical parameter is independent of its absolute location. This translational invariance aids in producing a larger number of input/output training pairs, since one must only shift a convolutional template over the training data set to produce additional input/output pairs of training data.

FIG. 2B illustrates the framework described above. Each geophysical data set of training data is first converted to the corresponding estimated physical parameters by an inversion procedure (220). (Inversion assumes a link between a model parameter and data. Then, given the observed data, it estimates the model parameter value that produced it.) For example, in accordance with one or more embodiments, by this process the seismic data may be converted to acoustic impedance or seismic wave propagation velocity, the EM data may be converted to resistivity, and the LWD data may be converted to pressure, temperature, gamma ray, or other parameters. Application of the methodology to produce these particular physical parameters is not a limitation of the method. Other physical parameters may be obtainable from each of the geophysical data types (e.g., density and velocity could also be obtained from seismic data).

Given a training data set of estimated physical parameters, the first CNN (228) defined above may be created to map the estimated physical parameters to related rock characteristic variables, such as lithology and saturation. The lithology and saturation would have been observed at the same physical location of the physical parameters being used. Given the pairs of input (estimated physical parameters) and output (lithology and saturation), the first CNN (228) is trained to map from the former to the latter. In FIG. 2C, a second CNN (229) is trained on the same data in the opposite direction, thus mapping lithology and saturation into predicted physical parameters.

In FIG. 2D, once trained, the first and second CNNs are applied sequentially in two parts. In the first part (262), the first CNN (228) takes the estimated physical parameters in the training data and converts them to lithology and/or saturation values. Then, in the second part (264), the second CNN (229) takes the lithology and/or saturation values and converts them back to predicted physical variable—this time with less noise and exhibiting realistic patterns picked up from the training data set of rock characteristics.

As shown in FIG. 2E, the original estimated physical parameters and their counterpart predicted physical parameters then form a new input/output training data set to train a third CNN (240). When applied to new input estimated physical parameter data set, the output of the third CNN (240) will be called “reconciled” physical parameters. Application of the third CNN (240) may be considered the third part (268) of the procedure for producing reconciled physical parameters, as shown in FIG. 2F.

Expert information may be incorporated into the first CNN (228), the second CNN (229), and the third CNN (240) by manually modifying their weights. Physical parameters from poor quality data (lower signal-to-noise ratio, and hence, higher uncertainty) may be given less weight in the CNNs as compared to physical parameters from high quality data. The quality of the CNNs is verified through results of testing on estimated physical parameters from nearby wells that were withheld for evaluation purposes. The quality of the CNNs is based on their testing accuracy score. For example, an accuracy score above 80% on the testing dataset is considered adequate. If the CNNs cannot reach this level of accuracy, it may be beneficial to find more training data, retrain, and then re-measure the accuracy score to ensure they have reached 80%.

One reason for using the CNNs of this method is their adaptability to, and automatic reconciliation of, various data sets. A second reason is that the CNNs may be very fast to operate on an input set of estimated physical parameters when compared to other methods. Furthermore, they allow expert information to be incorporated via manually adjusting the weights in the CNN. Thus, the results of this method are suitable for estimating subsurface variables that may be used before or during a drilling operation to plan a well trajectory.

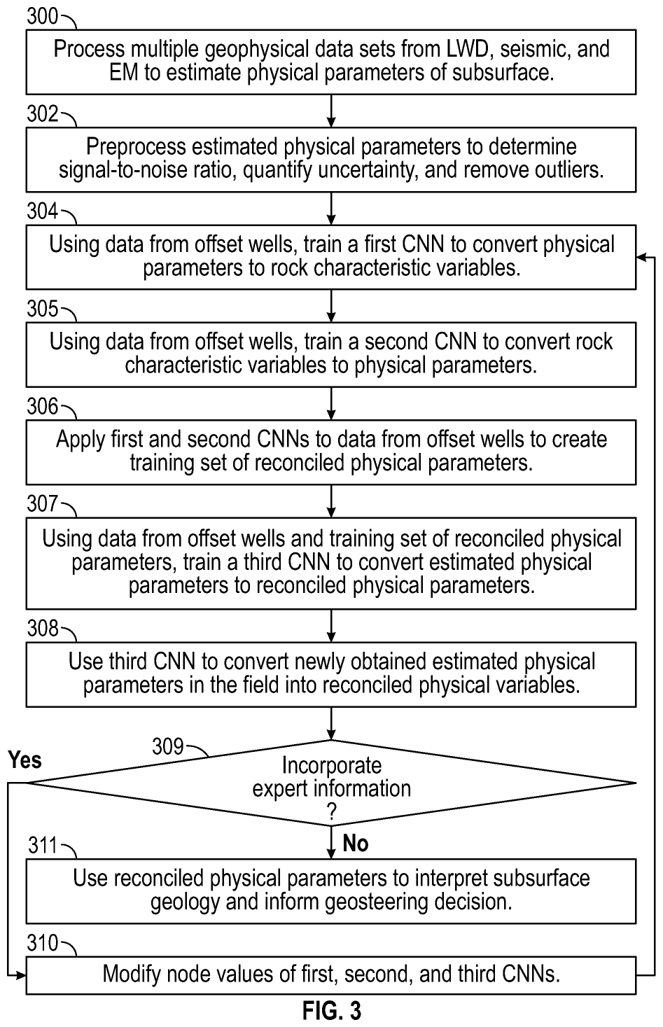

FIG. 3 shows a workflow in accordance with one or more embodiments. In Step 300, the individual geophysical data sets are processed independently to convert them into physical parameters of the subsurface (for example, seismic data is converted to impedance, EM data is converted to resistivity). In Step 302, any outliers or erroneous data may be removed from the geophysical parameters by any method or methods known in the art, without departing from the scope of the invention. Furthermore, signal-to-noise ratios may be determined and uncertainty in each geophysical parameter may be quantified.

Next, in Step 304, a first CNN (228) may be trained using data recorded, for example, in offset wells to convert each physical parameters into rock characteristic variables such as lithology and saturation. Expert information may be incorporated in the training. For example, expert information may be included by manually fixing the values of certain nodes (202) in the first CNN (228). Expert information may also be integrated in the form of manual filtering of data, adapting the weighting of entire datasets, and adapting the values of data.

In Step 305, a second CNN (229) may be trained to convert rock characteristic variables (e.g., lithology, saturation) into predicted physical parameters. The second CNN (229) may be trained using the same training data as the first CNN (228). Again, expert information may be incorporated in the training. The expert information may be included by manually fixing the values of certain nodes (202) in the second CNN (229).

In Step 306, the first CNN (228) and the second CNN (229) are used to take the estimated physical parameters in the training data and convert them first into predicted rock characteristics using the first CNN (228), and then back into predicted physical parameters using the second CNN (229). This generates a training data set of predicted physical parameters. In Step 307, the estimated physical parameters from the training data are paired with the predicted physical parameters that they produced through the two CNNs to train the third CNN (240). Next, in Step 308, the third CNN (240) is applied to new estimated physical parameters coming from a field data set. The output of the third CNN (240) are the reconciled physical parameters. The reconciled physical parameters are less noisy and contain more realistic patterns that the original estimated physical parameters.

At this point, in Step 309, an expert may examine the results and determine if the CNNs should be modified to produce specific outputs. If the decision is made to incorporate the expert information, the node values of the CNNs are modified in Step 310, and the training process of all the CNNs is repeated.

If no expert information is necessary in Step 309, the workflow continues to Step 311, where the reconciled physical parameters are used to interpret subsurface geology and inform a geosteering decision of an actively drilled well.

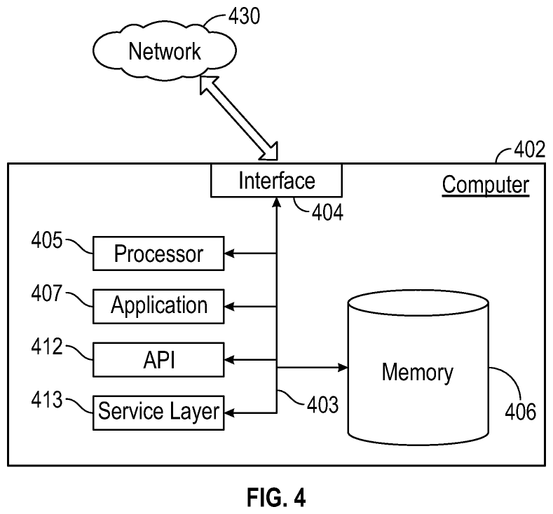

FIG. 4 depicts a block diagram of a computer system (402) used to provide computational functionalities associated with described algorithms, methods, functions, processes, flows, and procedures as described in this disclosure, according to one or more embodiments. The illustrated computer (402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The system for predicting conditions ahead of the drill bit may include a computing system such as the computing system shown in FIG. 4. The computing system may be the control system or any other computing system. The computing system, in one or more embodiments performs a method for predicting conditions ahead of the drill bit. The system for predicting conditions ahead of the drill bit may include other components, in addition to the computing system. For example, the system for predicting conditions ahead of the drill bit may include data sources other than those previously described.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or another suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), wherein each computer (402) communicates over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
estimating physical parameters from a training dataset comprising remote sensing data;
preprocessing the estimated physical parameters to determine a signal-to-noise ratio, quantify an uncertainty, and remove outliers;
training a first neural network to convert the estimated physical parameters to rock characteristics;
training a second neural network to convert the rock characteristics to the estimated physical parameters;
converting the rock characteristics into reconciled physical parameters with the second neural network;
converting the estimated physical parameters into the rock characteristics with the first neural network;
training a third neural network to convert the estimated physical parameters to reconciled physical parameters;
obtaining new remote sensing data;
estimating new estimated physical parameters from the new remote sensing data;
converting new estimated physical parameters into new reconciled physical parameters with the third neural network; and
performing geosteering of a well based on a subsurface geology interpreted from the new reconciled physical parameters.

2. The method of claim 1, wherein the remote sensing data comprises at least one selected from the group consisting of: logging while drilling (LWD) data and deep remote sensing data.

3. The method of claim 2, wherein the deep remote sensing data is at least one selected from the group consisting of: a deep seismic data set and a deep electromagnetic (EM) data set.

4. The method of claim 1, wherein the rock characteristics comprises a saturation.

5. The method of claim 2, wherein the LWD data comprises at least one selected from the group consisting of: neutron porosity data, borehole caliber data, nuclear magnetic resonance data, gamma ray data, weight on bit data, rate of penetration data, inclination data, measured depth data, true vertical depth data, bearing data, temperature data, and pressure data.

6. The method of claim 1, wherein the first neural network, the second neural network, and the third neural network are convolutional neural networks.

7. The method of claim 1, further comprising incorporating expert information in the first neural network, in the second neural network, and in the third neural network.

8. The method of claim 7, wherein the expert information comprises an uncertainty value.

9. The method of claim 1, wherein the training dataset comes from a nearby well.

10. A non-transitory computer-readable memory comprising computer-executable instructions stored thereon that, when executed on a processor, cause the processor to perform the steps of:
estimating physical parameters from a training dataset comprising remote sensing data;
preprocessing the estimated physical parameters to determine a signal-to-noise ratio, quantify an uncertainty, and remove outliers;
training a first neural network to convert the estimated physical parameters to rock characteristics;
training a second neural network to convert the rock characteristics to the estimated physical parameters;
converting the rock characteristics into reconciled physical parameters with the second neural network;
converting the estimated physical parameters into the rock characteristics with the first neural network;
training a third neural network to convert the estimated physical parameters to reconciled physical parameters;
obtaining new remote sensing data;
estimating new estimated physical parameters from the new remote sensing data; and
converting new estimated physical parameters into new reconciled physical parameters with the third neural network.

11. The non-transitory computer-readable memory of claim 10, wherein the remote sensing data comprises at least one selected from the group consisting of: logging while drilling (LWD) data and deep remote sensing data.

12. The non-transitory computer-readable memory of claim 11, wherein the deep remote sensing data is at least one selected from the group consisting of: a deep seismic data set and a deep electromagnetic (EM) data set.

13. The non-transitory computer-readable memory of claim 10, wherein the rock characteristics comprises a saturation.

14. The non-transitory computer-readable memory of claim 11, wherein the LWD data comprises at least one selected from the group consisting of: neutron porosity data, borehole caliber data, nuclear magnetic resonance data, gamma ray data, weight on bit data, rate of penetration data, inclination data, measured depth data, true vertical depth data, bearing data, temperature data, and pressure data.

15. The non-transitory computer-readable memory of claim 10, wherein the first neural network, the second neural network, and the third neural network are convolutional neural networks.

16. The non-transitory computer-readable memory of claim 10, further comprising incorporating expert information in the first neural network, the second neural network, and the third neural network.

17. The non-transitory computer-readable memory of claim 16, wherein the expert information comprises an uncertainty value.

18. A system for reconciling physical parameters, comprising:
a geosteering system configured to guide a drill bit in a well; and
a computer system configured to:
estimate physical parameters from a training dataset comprising remote sensing data,
preprocess the estimated physical parameters to determine a signal-to-noise ratio, quantify an uncertainty, and remove outliers,
train a first neural network to convert the estimated physical parameters to rock characteristics,
train a second neural network to convert the rock characteristics to the estimated physical parameters,
convert the rock characteristics into reconciled physical parameters with the second neural network,
convert the estimated physical parameters into the rock characteristics with the first neural network,
train a third neural network to convert the estimated physical parameters to reconciled physical parameters,
obtain new remote sensing data,
estimate new estimated physical parameters from the new remote sensing data,
convert new estimated physical parameters into new reconciled physical parameters with the third neural network, and
perform geosteering of the well based on a subsurface geology interpreted from the new reconciled physical parameters.

19. The system of claim 18, wherein the computer system is further configured to incorporate expert information in the first neural network, the second neural network, and the third neural network.

20. The computer system of claim 19, wherein the expert information comprises an uncertainty value.
